(19) United States
(12) Patent Application Publication
(10) Pub. No.: US 2022/0033997 A1
(43) Pub. Date: Feb. 3, 2022

(54) POLYURETHANE ELASTIC FIBER WITH FLAME RETARDANT FUNCTION AND PREPARATION METHOD THEREOF

(71) Applicant: YANTAI TAYHO ADVANCED MATERIALS CO., LTD., Yantai (CN)

(72) Inventors: Yongjun CHEN, Yantai (CN); Qianli MA, Yantai (CN)

(21) Appl. No.: 17/504,514

(22) Filed: Oct. 19, 2021

Related U.S. Application Data
(63) Continuation of application No. PCT/CN2019/096374, filed on Jul. 17, 2019.

(30) Foreign Application Priority Data
Apr. 22, 2019 (CN) 201910323978.4

(51) Int. Cl. D01F 6/94; C08G 18/50; C08G 18/46; D01F 1/07; D01D 5/04

(52) U.S. Cl. CPC D01F 6/94; C08G 18/5075; D10B 2331/10; D01F 1/07; D01D 5/04; C08G 18/4684

(57) ABSTRACT

Disclosed are a polyurethane elastic fiber with a flame retardant function and a preparation method thereof. The polyurethane elastic fiber is prepared by using a polyether diol containing phosphorus elements or a polyester diol containing phosphorus elements as a raw material to react with 4,4′-diphenylmethane diisocyanate to prepare a prepolymer, extending the chain using an organic amine to obtain a polyurethane solution, and dry spinning with the polymer solution to prepare the polyurethane fiber. The limit oxygen index of the prepared polyurethane fiber was between 25% and 32%.

### CROSS-REFERENCE TO RELATED APPLICATIONS

The present application is a continuation of International Patent Application No. PCT/CN2019/096374, filed on Jul. 17, 2019, which claims priority to Chinese patent application NO. 201910323978.4, filed on Apr. 22, 2019, the entire content of which is incorporated herein by reference.

### FIELD

The present disclosure relates to a preparation method of a polyurethane elastic fiber, in particular to a polyurethane elastic fiber with flame retardant function and a preparation method thereof.

### BACKGROUND

Polyurethane elastic fiber (commonly known as spandex) is a kind of textile fibers with high elasticity, and is widely used in knitted and woven elastic fabrics. Spandex can usually be combined with nylon, polyester, cotton, linen and other fibers to make fabrics, imparting the fabrics with characteristics such as close-fitting shaping, free expansion and contraction, and no pressure, and significantly improving the conformality, drapability and wrinkle resistance of clothing. The made fabrics are widely applied to various textile and garment fields, and are promoted and applied in the field of textiles used in industries such as automobile interiors.

Textiles are widely used, but they often become the first fired objects since they are usually composed of flammable and combustible natural or synthetic fibers. In order to reduce the occurrence of fires, America, Britain, Japan, Germany and other countries have issued relevant laws and regulations on the flame retardancy of textile fibers, which impose flame-retardant requirements on the production of clothing for children, the elderly, and the disabled, fabrics for indoor decorations, theater curtains, textile materials used in communication and transportation means and hotels, and uniforms for steel workers and soldiers, etc.

At present, the production of flame retardant fibers such as flame retardant cotton, flame retardant viscose, flame retardant polyester, etc. has been achieved through flame retardant finishing or addition of flame retardants; in addition, high-temperature resistant and intrinsically flame retardant fibers such as aramid fiber, polyimide, polyphenylene sulfide and other fibers have also been mass-produced and applied. Spandex is an indispensable “aginomoto-like” textile raw material in the modern textile and garment industry, and its flame retardant fiber is rarely reported. Patent application CN 201511003945. X introduces a method for preparing flame retardant polyurethane fiber by blending, which blends phenyl phosphate flame retardant and non-metal oxide synergistic flame retardant into the polyurethane polymer, and then spins them into fibers. The addition of the flame retardant by blending cannot achieve the desired flame retardant requirement if the addition amount is too small, and will affect the spinnability of the polymer and the mechanical performance of the fiber if the addition amount is too large. Patent application CN201310547567.6 introduces a method for preparing flame retardant polyurethane fibers by copolymerization, which uses hydroxyl-containing phosphorus flame retardant and chain extender together to react with the prepolymer to form a copolymer flame retardant polyurethane, and adds melamine flame retardant, aluminum oxide flame retardant, etc. by blending to achieve the flame retardant effect. Since the hydroxyl group in the hydroxyl-containing phosphorus flame retardant is less reactive than the amino group, and can hardly form an effective chemical bonding during chain extending with amine. Therefore, a content of the chemically introduced phosphorus is limited, which limits the actual flame retardant effect, and other flame retardants need to be blended.

### SUMMARY

The present disclosure provides a polyurethane elastic fiber with flame retardant function and a preparation method thereof to overcome the shortcomings of the related art. The polyurethane elastic fiber prepared according to the present disclosure has excellent flame retardant performance while maintaining the good elongation performance of polyurethane fiber.

In order to achieve the above object, the present disclosure adopts the following technical solutions:

A preparation method of a polyurethane elastic fiber with a flame retardant function, including the following steps:

step 1 of reacting a diol containing flame-retardant elements with excess 4,4′-diphenylmethane diisocyanate to prepare a prepolymer end-capped by isocyanate, and dissolving the prepolymer in an organic solvent to form a prepolymer solution;

step 2 of adding a diamine or a mixed amine of a diamine and a monoamine to the prepolymer solution for chain extension reaction to obtain a polyurethane solution; and

step 3 of mixing the polyurethane solution with an anti-yellowing agent and an antioxidant, followed by curing, filtering, defoaming, and then dry spinning to obtain the polyurethane elastic fiber with flame retardant function.

Further, the diol containing flame retardant elements in step 1 is a polyether diol containing phosphorus elements or a polyester diol containing phosphorus elements.

Further, the polyether diol containing phosphorus elements contains —P—O— or —P—C— structures, and has a phosphorus content of 0.5 wt % to 5 wt %; and the polyeste diol containing phosphorus elements contains phosphate structures, and has a phosphorus content of 0.5 wt % to 10 wt %, and an acid value of 3.0 or lower.

Further, the phosphorus content in the polyether diol containing phosphorus elements is 1 wt % to 3 wt %, the phosphorus content in the polyester diol containing phosphorus elements is 1 wt % to 6 wt %, and the acid value is 2.0 or lower.

Further, in step 1, a molar ratio of the 4,4′-diphenylmethane diisocyanate to the diol containing flame-retardant elements is (1.5:1) to (2.5:1).

Further, the organic solvent in step 1 is N,N-dimethylformamide, N,N-dimethylacetamide, or a mixture thereof.

Further, in step 2, a molar ratio of amino functional groups in the diamine or the mixed amine of the diamine and the monoamine to the isocyanate at ends of the prepolymer is (1.00:1) to (1.05:1).

Further, in step 2, the diamine is selected from the group consisting of ethylenediamine, 1,2-propanediamine, 1,3-propylenediamine 2-methyl-1,5-pentanediamine, and a combination thereof in any ratio; and the monoamine is selected from the group consisting of dimethylamine, diethylamine, methylethylamine, and a combination thereof in any ratio.

Further, when the mixed amine of the diamine and the monoamine is adopted in step 2, a molar ratio of the monoamine to the diamine is (0.02:1) to (0.15:1).

A polyurethane elastic fiber with a flame retardant function prepared by the above preparation method of the polyurethane elastic fiber with the flame retardant function. A limit oxygen index of the polyurethane elastic fiber is 25 wt % to 32 wt %.

Compared with the related art, the present disclosure has the following beneficial technical effects:

The present disclosure adopts phosphorus-containing diol as raw material, and introduces flame retardant elements into polyurethane molecules through reaction, which is intrinsically flame retardant; during use, the flame retardant function will not decline due to flame retardant migration and precipitation, and the flame retardant effect is long-lasting; the phosphorus element has excellent flame retardant performance, does not release hydrogen halide gas during combustion, and belongs to a class of environmentally friendly flame retardant elements; the phosphorus element was added in a low amount and was evenly distributed in the polyurethane molecule, which has little impact on the flexibility of the molecular chain; and the prepared fiber has good elongation performance. The polyurethane elastic fiber prepared by the present disclosure has excellent flame retardant performance, with a limit oxygen index between 25% and 32%, while maintains good elongation performance of the polyurethane fiber, with an elongation at break between 360% and 600%. Therefore, the elastic fiber prepared by the present disclosure can be used together with flame retardant cotton, flame retardant viscose, aramid fiber and other flame retardant fibers to make flame retardant yarns, fabrics, etc., which can be used in children's clothing, mattress fabrics, curtains, interiors of means of communication, protective working clothes, fire-fighting clothing and other flame retardant protective products.

### DESCRIPTION OF EMBODIMENTS

The embodiments of the present disclosure are described in further detail below:

A preparation method of a polyurethane elastic fiber with a flame retardant function, including the following steps:

(1) A diol containing flame retardant elements with a molecular weight of 1000 to 3000 was reacted with excess 4,4′-diphenylmethane diisocyanate (abbreviated as MDI) to prepare a prepolymer end-capped by isocyanate, and the prepolymer was dissolved in an organic solvent to form a prepolymer solution with a certain concentration;

The diol containing flame retardant elements is a polyether diol containing phosphorus elements or a polyester diol containing phosphorus elements. The polyether diol containing phosphorus elements contains —P—O— or —P—C— structures, and has a phosphorus content of 0.5 wt % to 5 wt %, preferably 1% to 3%; and the polyester diol containing phosphorus elements contains phosphate structures, and has a phosphorus content of 0.5 wt % to l0 wt %, preferably 1% to 6%, and an acid value of 3.0 or lower, preferably 2.0 or lower; the organic solvent is one or more of N,N-dimethylformamide (DMF) and N,N-dimethylacetamide (DMAc); and a molar ratio of MDI to the diol containing flame-retardant elements is (1.5:1) to (2.5:1);

(2) a diamine or a mixed amine of a diamine and a monoamine is added to the prepolymer solution for chain extension reaction to obtain a polyurethane solution;

A molar ratio of an amino functional group in the diamine or the mixed amine of the diamine and the monoamine to the isocyanate at ends of the prepolymer is (1.00:1) to (1.05:1); the diamine is one or more of ethylenediamine, 1,2-propanediamine, 1,3-propanediamine, or 2-methyl-1,5-pentanediamine (MPDA), and serves as an reactive chain extender; the monoamine is one or more of dimethylamine, diethylamine or methylethylamine, and serves as a molecular weight regulator for controlling the reaction viscosity; and a molar ratio of the monoamine to the diamine is (0.02:1) to (0.15:1);

(3) the polyurethane solution is mixed with various anti-yellowing agents (such as TAS-011, HN-150), antioxidants (such as HW-245, antioxidant 1790) and other additives, followed by curing, filtering, defoaming, and then dry spinning to obtain the polyurethane elastic fiber; the limit oxygen index (LOI) of the polyurethane fiber prepared according to the method reaches 25 wt % to 32 wt %.

The present disclosure will be further described in detail below in conjunction with embodiments:

In the embodiments, the following methods are adopted to measure the performances of polyurethane fibers.

Evaluation of Limit Oxygen Index

(1) Solution preparation: the prepared polyurethane solution was diluted with a solvent to a polymer solution with a solid content of 10% to 15%; or the prepared fiber was washed to remove the surface oil, followed by drying, dissolving, and then formulating into a polymer solution.

(2) Film making: after being stirred evenly, the polymer solution was let stand for a period of time to remove bubbles from the solution. Then, the solution was heated to 40° C. to 60° C. and cast on a smooth and clean glass plate to form a film. After being let stand at room temperature for 12 hours, the film was dried at 100° C. for 2 hours. A film with a thickness of approximately 2 mm was obtained.

(3) Measurement: an oxygen index instrument was adopted to measure the limit oxygen index.

Evaluation of Elongation at Break

A Constant-Rate-of-Extension type tensile testing machine was adopted to test the elongation rate of the spandex at break under the condition of a tensile rate of 500 mm/min.

### Embodiment 1

Preparation of Phosphorus-Containing Polyether Diol:

800 g of phenylphosphoric acid was put into a 5 L reactor, under the condition of constant stirring and mixing, the reaction temperature was increased up to 90° C., then 696 g of propylene oxide (a first feeding) was added into the reactor within 4 hours, the reaction was continued until the reaction pressure dropped to normal pressure, 20 g of potassium hydroxide was added, and the intermediate product was vacuumed for 1 hour to a degree of vacuum of −0.1 atm. Then, 1722 g of propylene oxide (a second feeding) was added to the reactor within 8 hours, and the reaction was continued until the reaction pressure dropped to normal pressure to obtain the crude product. The crude product was vacuumed for 1 hour to a degree of vacuum of −0.1 atm to completely remove the residual monomers and volatile components in the crude product, neutralized by adding phosphoric acid, adsorbed by diatomaceous earth, and filtered, to finally obtain a viscous transparent liquid product. After testing, the hydroxyl value was 181 mg/gKOH, the acid value was 0.2 mg/gKOH, and the number average molecular weight was 620; and according to calculation based on the feed amount and the product mass, the phosphorus content of the product was 5 wt %.

Preparation of Polyurethane Fiber:

The phosphorus-containing polyether diol prepared above and 4,4′-diphenylmethylalkane diisocyanate (MDI) at a molar amount equivalent to 1.5 times that of the phosphorus-containing polyether diol were reacted at 80° C. for 3 hours under the protection of dry nitrogen and mechanical stirring to obtain a prepolymer end-capped by —NCO. After cooling to room temperature, N,N-dimethylacetamide (DMAc) was added to dissolve the prepolymer to form a prepolymer solution.

The temperature of the above prepolymer solution was lowered to 10° C., and a DMAc solution of a mixed amine of 1,2-propanediamine and diethylamine was added for chain extension to obtain a polyurethane solution. The molar ratio of diethylamine to (1,2-propylenediamine) was 0.15:1, and the molar ratio of amino functional groups in the mixed amine to isocyanate functional groups in the prepolymer (NHx:NCO) was 1.05:1. An anti-yellowing agent TAS-011 accounting for 0.5 wt % of the weight of the polymer and an antioxidant 1790 accounting for 0.5 wt % of the weight of the polymer were added to the polyurethane solution, followed by mixing evenly, then curing, defoaming, and filtering, and then dry spinning to obtain 560 denier (abbreviated as D) polyurethane fiber.

### Embodiments 2 to 5

Preparation of Phosphorus-Containing Polyether Diol:

According to the preparation method of polyether diol in Embodiment 1, polyether diols containing 3%, 2%, 1%, and 0.5% phosphorus were prepared. In order to control the molecular weight, when preparing a polyether diol with a lower phosphorus content, it was necessary to add diethylene glycol to adjust the molecular weight at the same time when adding potassium hydroxide. The specific feeding amount and performance indicators are shown in Table 1.

TABLE 1
Feed and performance indicators of phosphorus-containing polyether diol

| Items | | Embodiment 1 | Embodiment 2 | Embodiment 3 | Embodiment 4 | Embodiment 5 |
|---|---|---|---|---|---|---|
| Feed (g) | Phenylphosphoric | 800 | 500 | 350 | 172 | 84 |
| | acid | | | | | |
| | Propylene oxide | 696 | 435 | 304 | 150 | 73 |
| | (First feeding) | | | | | |
| | Diethylene | 0 | 0 | 0 | 0 | 120 |
| | glycol | | | | | |
| | Propylene oxide | 1722 | 2450 | 2900 | 3100 | 3200 |
| | (Second feeding) | | | | | |
| Performance | Acid value | 0.2 | 0.1 | 0.1 | 0.1 | 0.1 |
| indicators | mgKOH/g | | | | | |
| | Hydroxyl value | 181 | 109 | 73 | 37 | 56 |
| | mgKOH/g | | | | | |
| | Number average | 620 | 1030 | 1540 | 3000 | 2000 |
| | molecular | | | | | |
| | weight g/mol | | | | | |
| | Phosphorus | 5% | 3% | 2% | 1% | 0.50% |
| | content wt % | | | | | |

Preparation of Polyurethane Fiber:

The polyether diol in the above embodiments 2 to 5 was used as the raw material, and according to the preparation method of the polyurethane fiber in Embodiment 1, after the molar ratio of MDI to polyether diol and the type and amount of chain extender were adjusted according to Table 2, a polyurethane solution was prepared, followed by curing, defoaming, filtering, and then spinning to obtain 40D or 560D polyurethane fiber.

The limit oxygen index and the elongation at break of polyurethane fiber are shown in Table 2.

TABLE 2
Feed and performance indicators of phosphorus-containing polyether diol based polyurethane fiber

| Items | | Embodiment 1 | Embodiment 2 | Embodiment 3 | Embodiment 4 | Embodiment 5 |
|---|---|---|---|---|---|---|
| Phosphorus content | | 5% | 3% | 2% | 1% | 0.5% |
| of polyether diol wt % | | | | | | |
| Feed | MDI/Diol | 1.5 | 1.5 | 2 | 2 | 2.5 |
| (molar ratio) | NHx:NCO | 1.05 | 1 | 1 | 1.03 | 1.05 |
| | Monoamine: | 0.15 | / | 0.02 | 0.10 | 0.10 |
| | Diamine | | | | | |
| | Diamine | 1,2- | Ethylenediamine | Ethylenediamine: | 1,2-Propanediamine: | 1,2- |
| | | propanediamine | | MPDA = 8:2 | 1,3-propanediamine = | propanediamine |
| | Monoamine | Diethylamine | None | Diethylamine: | 8:2 Methylethylamine | Dimethylamine |
| | | | | Methylethylamine = | | |
| | | | | 9:1 | | |
| Performance | Fiber size | 560D | 560D | 40D | 40D | 560D |
| indicators | LOI % | 32 | 29 | 28 | 26 | 25 |
| | Elongation | 360 | 420 | 550 | 580 | 530 |
| | at break % | | | | | |

### Embodiment 6

Preparation of Phosphorus-Containing Polyester Diol:

218 g of adipic acid, 2200 g of (2-carboxyethyl)phenylphosphinic acid (CEPPA) and 1248 g of 1,4-butanediol were added into a 5 L reactor, 1.5 g of catalyst tetrabutyl titanate was added, followed by stirring under the protection of nitrogen, and gradually heating up to 125-150° C., the water started to be fractionally distilled out, and the reaction lasted for 2 hours to 8 hours while controlling the reaction temperature in the range; then the temperature was further increased to 180° C., at which temperature the reactor was vacuumed to 20 Pa to 5000 Pa, followed by slowly heating up to 235° C. After reacting for 2-4 hours, the acid value and hydroxyl value were tested every 30 minutes. After the acid value and hydroxyl value were qualified, the heating was stopped. The pressure was relieved with nitrogen and the temperature was lowered. When the temperature dropped to 80° C., the reaction product was taken out to obtain phosphorus-containing polyester diol. After testing, the hydroxyl value was 36 mg/gKOH, the acid value was 1.7 mg/gKOH, and the number average molecular weight was 3000. According to calculation based on the feed amount and product mass, the phosphorus content of the product was 10 wt %.

Preparation of Polyurethane Fiber:

The above polyester diol was used as raw material. 560D polyurethane fiber was prepared according to the preparation method of the polyurethane fiber in Embodiment 1. The solvent DMAc was replaced by a mixed solvent of 80 wt % DMF and 20 wt % DMAc, the anti-yellowing agent was replaced by HN-150, and the antioxidant was replaced by antioxidant 245.

### Embodiments 7 to 10

Preparation of Phosphorus-Containing Polyester Diol:

According to the preparation method of polyester diol in Embodiment 6, the polyester diols containing 6%, 3%, 1%, and 0.5% phosphorus were prepared. The mixed solvent was replaced by pure DMF. See Table 3 for specific feeding amount and performance indicators.

TABLE 3
Feed and performance indicators of phosphorus-containing polyester diol

| Items | | Embodiment 6 | Embodiment 7 | Embodiment 8 | Embodiment 9 | Embodiment 10 |
|---|---|---|---|---|---|---|
| Feed (g) | CEPPA | 2200 | 1420 | 700 | 236 | 115 |
| | Adipic acid | 218 | 1100 | 1680 | 2100 | 2100 |
| | Butanediol | 1248 | 1490 | 1604 | 1672 | 1776 |
| Performance | Acid value | 1.7 | 1.9 | 1.7 | 2.0 | 2.9 |
| indicators | mgKOH/g | | | | | |
| | Hydroxyl | 36 | 36 | 54 | 54 | 109 |
| | value | | | | | |
| | mgKOH/g | | | | | |
| | Number average | 3000 | 3000 | 2000 | 2000 | 1000 |
| | molecular weight | | | | | |
| | g/mol | | | | | |
| | Phosphorus content | 10% | 6% | 3% | 1% | 0.5% |
| | wt % | | | | | |

Preparation of Polyurethane Fiber:

The polyester diols in the above Embodiments 7 to 10 was used as raw materials. According to the preparation method of the polyurethane fiber in Embodiment 6, after the molar ratio of MDI to polyether diol and the type and amount of chain extender were adjusted according to Table 4, the polyurethane solution was prepared, followed by curing, defoaming, filtering, and then spinning to obtain 40D or 560D polyurethane fibers.

The limit oxygen index and the elongation at break of polyurethane fiber are shown in Table 4.

TABLE 4
Feed and performance indicators of phosphorous-containing polyester diol based polyurethane fiber

| Items | | Embodiment 6 | Embodiment 7 | Embodiment 8 | Embodiment 9 | Embodiment 10 |
|---|---|---|---|---|---|---|
| Phosphorus content of | | 10% | 6% | 3% | 1% | 0.5% |
| polyester diol wt % | | | | | | |
| Feed | MDI/Diol | 1.5 | 1.5 | 2 | 2 | 2.5 |
| (Molar ratio) | NHx:NCO | 1.05 | 1 | 1 | 1.03 | 1.05 |
| | Monoamine: | 0.15 | / | 0.02 | 0.10 | 0.10 |
| | Diamine | | | | | |
| | Diamine | 1,2- | Ethylenediamine | Ethylenediamine: | 1,2-Propanediamine: | 1,2- |
| | | propanediamine | | MPDA = 8:2 | 1,3-propanediamine = | propanediamine |
| | Monoamine | Diethylamine | None | Diethylamine: | 8:2 Methylethylamine | Dimethylamine |
| | | | | Methylethylamine = | | |
| | | | | 9:1 | | |
| Performance | Fiber size | 560D | 560D | 40D | 560D | 560D |
| indicators | LOI% | 32 | 29 | 27 | 26 | 25 |
| | Elongation at | 480 | 520 | 600 | 570 | 430 |
| | break % | | | | | |

### Comparative Embodiment 1

The flame retardant polyether diol in Embodiment 4 was replaced by polytetrahydrofuran diol (PTMG), and a polyurethane solution was prepared according to the method of Embodiment 4 and spun into 40D polyurethane fiber.

### Comparative Embodiment 2

A polyurethane solution was prepared according to the method of Comparative Embodiment 1, and a high nitrogen flame retardant HT-211 accounting for 2% of the weight of the polymer was added as a flame retardant auxiliary, followed by mixing, curing, filtering, defoaming, and then dry spinning to form 40D polyurethane fiber.

### Comparative Embodiment 3

A polyurethane solution was prepared according to the method of Embodiment 4, and high nitrogen flame retardant HT-211 accounting for 2% of the weight of the polymer was added as a flame retardant auxiliary, followed by mixing, curing, filtering, defoaming, and then dry spinning to form 40D polyurethane fiber.

### Comparative Embodiment 4

A polyurethane solution was prepared according to the method of Embodiment 9, and high nitrogen flame retardant HT-211 accounting for 5% of the weight of the polymer was added as a flame retardant auxiliary, followed by mixing, curing, filtering, defoaming, and then dry spinning to form 560D polyurethane fiber.

TABLE 5
Feed and performance indicators of different comparative embodiments

| | | Comparative | Comparative | Comparative | Comparative |
|---|---|---|---|---|---|
| | | Embodiment | Embodiment | Embodiment | Embodiment |
| Items | | 1 | 2 | 3 | 4 |
| Diol | Types | PTMG | PTMG | Polyether-type | Polyester-type |
| | Phosphorus | 0 | 0 | 1% | 1% |
| | content | | | | |
| | wt % | | | | |
| Flame | Content | 0 | 5% | 2% | 5% |
| retardant | wt % | | | | |
| Performance | Fiber size | 40D | 40D | 40D | 560D |
| indicators | LOI % | 18 | 23 | 27 | 28 |
| | Elongation | 640 | 540 | 520 | 500 |
| | at break % | | | | |

What is claimed is:

1. A preparation method of a polyurethane elastic fiber with a flame retardant function, comprising:
step 1 of reacting a diol containing flame-retardant elements with excess 4,4′-diphenylmethane diisocyanate to prepare a prepolymer end-capped by isocyanate, and dissolving the prepolymer in an organic solvent to form a prepolymer solution;
step 2 of adding a diamine or a mixed amine of a diamine and a monoamine to the prepolymer solution for chain extension reaction to obtain a polyurethane solution; and
step 3 of mixing the polyurethane solution with an anti-yellowing agent and an antioxidant, followed by curing, filtering, defoaming, and then dry spinning to obtain the polyurethane elastic fiber with flame retardant function.

2. The preparation method of the polyurethane elastic fiber with the flame retardant function according to claim 1, wherein the diol containing flame-retardant elements in step 1 is a polyether diol containing phosphorus elements or a polyester diol containing phosphorus elements.

3. The preparation method of the polyurethane elastic fiber with the flame retardant function according to claim 2, wherein the polyether diol containing phosphorus elements contains —P—O— or —P—C— structures, and has a phosphorus content of 0.5 wt % to 5 wt %; and the polyether diol containing phosphorus elements contains phosphate structures, and has a phosphorus content of 0.5 wt % to l0 wt %, and an acid value of 3.0 or lower.

4. The preparation method of the polyurethane elastic fiber with the flame retardant function according to claim 3, wherein the phosphorus content in the polyether diol containing phosphorus elements is 1 wt % to 3 wt %, the phosphorus content in the polyester diol containing phosphorus elements is 1 wt % to 6 wt %, and the acid value is 2.0 or lower.

5. The preparation method of the polyurethane elastic fiber with the flame retardant function according to claim 1, wherein in step 1, a molar ratio of the 4,4′-diphenylmethane diisocyanate to the diol containing flame-retardant elements is (1.5:1) to (2.5:1).

6. The preparation method of the polyurethane elastic fiber with the flame retardant function according to claim 1, wherein the organic solvent in step 1 is N,N-dimethylformamide, N,N-dimethylacetamide, or a mixture thereof.

7. The preparation method of the polyurethane elastic fiber with the flame retardant function according to claim 1, wherein, in step 2, a molar ratio of amino functional groups in the diamine or the mixed amine of the diamine and the monoamine to the isocyanate at ends of the prepolymer is (1.00:1) to (1.05:1).

8. The preparation method of the polyurethane elastic fiber with the flame retardant function according to claim 1, wherein in step 2, the diamine is selected from the group consisting of ethylenediamine, 1,2-propanediamine, 1,3-propylenediamine 2-methyl-1,5-pentanediamine, and a combination thereof in any ratio; and the monoamine is selected from the group consisting of dimethylamine, diethylamine, methylethylamine, and a combination thereof in any ratio.

9. The preparation method of the polyurethane elastic fiber with the flame retardant function according to claim 1, wherein, when the mixed amine of the diamine and the monoamine is adopted in step 2, a molar ratio of the monoamine to the diamine is (0.02:1) to (0.15:1).

10. A polyurethane elastic fiber with a flame retardant function, prepared by the preparation method of the polyurethane elastic fiber with the flame retardant function according to claim 1, wherein a limit oxygen index of the polyurethane elastic fiber is 25 wt % to 32 wt %.
